(19) United States
(12) Patent Application Publication
(10) Pub. No.: US 2023/0240313 A1
(43) Pub. Date: Aug. 3, 2023

(54) PROCESS FOR PREPARING SHELF-STABLE PLANT-BASED YOGURT ANALOGUES AND YOGURT ANALOGUES THEREOF

(71) Applicant: SOCIÉTÉ DES PRODUITS NESTLÉ S.A., VEVEY (CH)

(72) Inventors: ANNE ROHART, Chateaurenard (FR); SEBASTIEN RADIGUET, Lisieux (FR)

(21) Appl. No.: 18/003,170

(22) PCT Filed: Jun. 24, 2021
(86) PCT No.: PCT/EP2021/067372

§ 371 Date: Dec. 23, 2022

(30) Foreign Application Priority Data
Jun. 26, 2020 (EP) 20182709.4

(51) Int. Cl. A23C 11/10

(52) U.S. Cl. CPC A23C 11/106

(57) ABSTRACT

A process for preparing a shelf-stable plant-based yogurt analogue is disclosed. A plant-based food composition comprising from 3.5 wt % to 6.0 wt % of plant proteins is first provided. Thereafter, the plant-based food composition is homogenized and eat treated. The heat-treated and homogenized plant-based food composition is then inoculated with at least one starter culture. The Inoculated plant-based food composition is afterwards fermented until reaching a pH from 4.5 and 5.0 to obtain a plant-based yogurt analogue. Finally, the obtained plant-based yogurt analogue undergoes a second heat treatment to obtain a shelf-stable plant-based yogurt analogue. A shelf-stable plant-based yogurt analogue obtained by such a process and a food product comprising said plant-based yogurt analogue are also disclosed.

### TECHNICAL FIELD

The present invention relates generally to the field of plant-based yogurt analogue. In particular, the present invention relates to a process for preparing a shelf-stable plant-based yogurt analogue and a plant-based yogurt analogue obtained by such a process.

### BACKGROUND OF THE INVENTION

Nowadays, more and more consumers are following alternative diets such as veganism, vegetarism, flexitarism and dairy-free diets. The vegan, vegetarian, flexitarian and dairy-free diets imply, to different extents, the consumption of food products of non-animal origin, including non-dairy food products. Food companies meet this new demand by offering food products of non-animal origin, including non-dairy food products. The amount of non-dairy food products on the market, including plant-based yogurt analogues is continuously growing.

A major part of the plant-based yogurt analogues on the market contain thickening agents or soy-based ingredients. However, thickening agents and soy-based ingredients are rejected by consumers for health, nutritional and sustainability reasons.

In addition, the plant-based yogurt analogues on the market shall be stored under chilled conditions, that-is-to-say at a temperature of 1° C. to 10° C. and have a shelf-life of 30 days under chilled conditions. However, such chilled plant-based yogurt analogues may not be convenient for the consumers because they have a limited shelf-life of several days and cannot be safely taken away or stored in shelves without the need of a cold storage. They shall be stored under chilled condition (e.g. in a fridge) and shall be directly consume after taking it out of the fridge to avoid any sanitary and hygienic risks.

Moreover, the manufacture of plant-based yogurt analogues involves a second heat-treatment after fermentation. This second heat-treatment is known to provide drawbacks in relation to the dairy yogurts such as the generation of off-flavours, a loss of texture and the appearance of an unpleasant granular texture due to protein precipitation. To overcome these drawbacks, especially the loss of texture and the granular texture, thickening agents are often added in the fermented dairy product before the second heat treatment to protect the proteins from precipitation and compensate the loss of texture. However, thickening agents, mostly artificial thickening agents, are avoided by consumers.

Chilled plant-based yogurt analogues are known and disclosed in the prior art documents, but no shelf-stable plant-based yogurt analogue equivalents are disclosed. WO2017/153669A1 (Roquette Freres) relates to a nutritional composition, for example a yogurt, comprising a pea protein isolate. The pea protein isolate has between 0.5% and 2% of free amino acids. The pea protein isolate also has a viscosity of 13 to 16.10-3 Pa·s at a shear rate of 10 s−1, of 10 to 14.10-3 at a shear rate of 40 s−1, and of 9.8 to 14.10-3 Pa·s at a shear rate of 600s−1. Moreover, the pea protein isolate has a solubility of 30 to 40% in pH ranging from 4 to 5 and a solubility of 40 to 70% in pH ranging from 6 to 8. Example 7 discloses the preparation of a stirred yogurt with such a pea protein isolate. After fermentation, the yogurt is smoothed and stored at 4° C. The obtained stirred yogurt comprises modified starch and dairy proteins in addition to pea proteins.

WO2017/195093A1 (Ripple Foods, PBC) relates to non-dairy yogurt analogues having qualities similar to dairy-based yogurts. The non-dairy yogurt analogues comprise between 1% to 10% of a plant protein and between 1 to 90% of a plant protein isolate.

WO2019/180037A1 (Cosucra Groupe Warcoing S. A.) relates to a kit for the preparation of a non-dairy vegetable-based yogurts. The kit contains a first powder portion comprising vegetable proteins and optionally a non-dairy food ingredient different from a protein. The kit contains a second powder portion comprising ferments, carbohydrates and an element selected from the group consisting of flavours, soluble fibres and mixtures thereof. This document discloses a process for manufacturing a vegetable-based yogurt with said kit. After mixing the two powders, the mixture is fermented by placing it in a temperature-controlled chamber until reaching a pH below 5. After fermentation, the obtained non-dairy vegetable-based yogurt is stored in a fridge till consumption.

WO2019/069111A1 (Yoplait France S.A.S.) relates to a method of making non-dairy fermented food products having substantially no added stabilizers, a viscosity of at least 0.4 Pa·s at 60s⁻¹ at 10° C. and a firmness of at least 40 g at 10° C. The method disclosed comprises the step of providing a liquid mixture comprising 3% to 12% of pea proteins and sugar and heating this liquid mixture at a temperature between 65° C. and 120° C. The method further comprises the step of inoculating the liquid mixture with a lactic acid bacterial culture and fermenting the liquid mixture to reach a pH of less than 4.7 to obtain a non-dairy fermented food product.

However, none of the products disclosed in the foregoing documents are suitable to be stored under ambient conditions for several months while keeping a satisfactory texture, taste and microbial load over the shelf-life. Especially, the precipitation of the plant proteins upon heat treatment, after fermentation, at high temperatures cannot be controlled, limited or even avoided in the prior art. This generates final products with an unpleasant greany and gritty texture in mouth.

Hence, there is a need to provide shelf-stable plant-based yogurt analogues, with a significant amount of proteins, that have a shelf-life of several months under ambient conditions (i.e. from 20° C. to 35° C.). Especially, there is a need for the shelf-stable plant-based yogurt analogues having a smooth texture (i.e. no protein precipitation) and a texture mimicking the texture of standard dairy yogurts. Moreover, the shelf-stable plant-based yogurt analogues should have limited off-notes.

Any reference to prior art documents in this specification is not to be considered an admission that such prior art is widely known or forms part of the common general knowledge in the field.

### SUMMARY OF THE INVENTION

The object of the present invention is to improve the state of the art, and in particular to provide a process that overcomes the problems of the prior art and addresses the needs described above, or at least to provide a useful alternative.

Accordingly, the invention provides a process for preparing a shelf-stable plant-based yogurt analogue, which comprises the steps of:
(a) providing a plant-based food composition comprising a hydrophilic liquid, a fermentable sugar, and plant proteins, wherein said plant-based food composition comprises from 3.5 wt % to 6.0 wt % of plant proteins, wherein the plant-based food composition is free from soy and dairy components,
(b) homogenizing the plant-based food composition at a pressure from 50 bar to 700 bar,
(c) heat-treating the plant-based food composition at a temperature from 80° C. to 100° C. for 1 minute to 10 minutes,
(d) inoculating the heat-treated and homogenized plant-based food composition with at least one starter culture to obtain an inoculated plant-based food composition,
(e) fermenting the inoculated plant-based food composition until reaching a pH from 4.5 and 6.2, preferably from 4.5 to 5.0, to obtain a plant-based yogurt analogue,
(f) heat-treating the plant-based yogurt analogue at a temperature from 80° C. to 110° C. for 5 seconds to 90 seconds to obtain a shelf-stable plant-based yogurt analogue.

Preferably, the fermentable sugar is sucrose.

Preferably, the plant-based food composition comprises from 3 wt % to 10 wt % of fermentable sugar.

In an embodiment, the plant proteins are pulse proteins, preferably pea proteins or fava bean proteins or a combination thereof.

Preferably, the homogenization step is performed at a temperature from 50° C. to 60° C.

Preferably, the shelf-stable plant-based yogurt analogue has a shelf-life of at least 3 months at a temperature of 20° C. to 35° C.

In an embodiment, the shelf-stable plant-based yogurt analogue has a firmness (g) of at least 35 g at 8° C., preferably a firmness ranging from 40 g to 65 g at 8° C., measured by means of a texturometer with a 30 mm diameter cylindrical flat probe penetrating at a crosshead speed of 0.5 mm·s⁻¹ and to a depth of 30 mm and has a viscosity of at least 0.4 Pa·s at 60 s⁻¹ at 10° C. measured by means of a rheometer with coaxial cylinders.

Preferably, the shelf-stable plant-based yogurt analogue has a mean protein particle size ranging from 1 μm to 70 μm, measured at room temperature by means of a laser diffraction analyzer, applying the Fraunhofer optical model, with a refractive index of 1.5.

In an embodiment, the shelf-stable plant-based yogurt analogue is substantially free, preferably entirely free, from any added thickening agents.

In an embodiment, the process further comprises after step (e) and prior to step (f) the addition of at least one natural thickening agent, preferably pectin, to the plant-based yogurt analogue.

In an embodiment, the plant-based food composition of step a) further comprises at least one natural thickening agent, preferably native starch.

Preferably, the shelf-stable plant-based yogurt analogue comprises from 0.4 wt % to 2.0 wt % of natural thickening agent.

The invention also provides a shelf-stable plant-based yogurt analogue obtained by the above-mentioned process.

The invention also provides a shelf-stable plant-based yogurt analogue, wherein said shelf-stable plant-based yogurt analogue is free from soy and dairy components and said shelf-stable plant-based yogurt analogue comprises:
a hydrophilic liquid, preferably water or a plant-based milk alternative,
a fermentable sugar, preferably sucrose,
plant proteins, preferably pulse proteins, more preferably pea proteins or fava bean proteins or a combination thereof, and said shelf-stable plant-based yogurt analogue has:
a pH of 4.5 to 6.2, preferably of 4.5 to 5.0,
from 3.5 wt % to 6.0 wt % of plant protein,
a shelf-life of at least 3 months at a temperature of 20° C. to 35° C.

In an embodiment, the shelf-stable plant-based yogurt analogue has a firmness (g) of at least 35 g at 8° C., preferably ranging from 40 g to 65 g at 8° C., measured by means of a texturometer with a 30 mm diameter cylindrical flat probe penetrating at a crosshead speed of 0.5 mm·s⁻¹ and to a depth of 30 mm and has a viscosity of at least 0.4 Pa·s at 60s⁻¹ at 10° C. measured by means of a rheometer with coaxial cylinders.

In an embodiment, the shelf-stable plant-based yogurt analogue has a mean protein particle size ranging from 1 to 70 μm, measured at room temperature by means of a laser diffraction analyzer, applying the Fraunhofer optical model, with a refractive index of 1.5.

The invention also provides a food product which comprises a shelf-stable plant-based yogurt analogue as mentioned above.

These and other aspects, features and advantages of the invention will become more apparent to those skilled in the art from the detailed description of embodiments of the invention, in connection with the attached drawings.

### BRIEF DESCRIPTION OF THE DRAWINGS

FIG. 1A shows the particle size distribution (PSD) of untreated coconut cream (24% fat) and the PSD of the coconut-based food composition of variant 1 before homogenization (nH) or after homogenization (H) and before heat-treatment (nHT) or after heat-treatment

FIG. 1B shows the particle size distribution of the coconut-based food composition of variant 1 (Coco-Pea) before heat-treatment (before HT) or after heat-treatment (after HT) and the particle size distribution of the coconut-based food composition of variant 4 comprising starch (Coco-Pea-Starch) before heat-treatment (before HT) or after heat-treatment (after HT).

FIG. 2 shows the particle size distribution of chilled (Ch.) or shelf-stable (Sh., i.e. after a second heat-treatment of the (0% plant-based yogurt analogue after fermentation) plant-based yogurt analogue variant 1 produced with coconut milk (prepared with coconut cream) and pea proteins without addition of pectin Pe). Image obtained by optical microscopy of the shelf-stable plant-based yogurt analogue. Bar scale represents 100 μm.

FIG. 3 shows the particle size distribution of chilled (Ch.) or shelf-stable (Sh., i.e. after a second heat-treatment of the plant-based yogurt analogue after fermentation) plant-based yogurt analogue produced with coconut milk (prepared with coconut cream) and pea proteins and comprising 0.5% (0.5% Pe) or 1% pectin (1% Pe). The plant-based yogurt analogues comprising 0.5% pectin correspond to variant 2. The plant-based yogurt analogues comprising 1% pectin correspond to variant 3. Images were obtained by optical microscopy of the chilled (top) and shelf-stable (bottom) plant-based yogurt analogue variant 3 comprising 1% pectin. Bar scale represents 100 μm.

FIG. 4A shows the particle size distribution of plant-based yogurt analogue variant 3 produced with coconut milk (prepared with coconut cream) and pea proteins, either chilled (Ch.) without (0% Pe) or with 1% pectin (1% Pe), or shelf-stable (Sh., i.e. after a second heat-treatment of the plant-based yogurt analogue after fermentation) with 1% pectin (1% Pe).

FIG. 4B shows the particle size distribution of plant-based yogurt analogue variant 5 produced with almond milk (prepared with almond cream) and pea proteins, either chilled (Ch.) without pectin (0% Pe) or with 1% pectin (1% Pe), or shelf-stable (Sh.) with 1% pectin (1% Pe).

FIG. 5 shows the particle size distribution of chilled (Ch.) or shelf-stable (Sh., i.e. after a second heat-treatment of the plant-based yogurt analogue, after fermentation) plant-based yogurt analogue produced with coconut milk (prepared with coconut cream) and pea proteins with 1% pectin and without starch (+Pectin) or with addition of both pectin and native starch (Starch+Pectin). The plant-based yogurt analogues with pectin but without native starch, chilled (Chilled) or shelfstable (Sh.+Pectin), correspond to variant 3. The plant-based yogurt analogues with pectin and native starch, chilled (Ch. Starch+Pectin) or shelfstable (Sh. Starch+Pectin), correspond to variant 4.

FIG. 6 shows the visual aspect at day+7 and day+30 after production of chilled or shelf-stable (i.e. after a second heat-treatment of the plant-based yogurt analogue, after fermentation) plant-based yogurt analogue produced with coconut milk (prepared with coconut cream) and pea proteins without or with 0.5% or 1% pectin. The plant-based yogurt analogues, chilled or shelfstable, without pectin correspond to variant 1, with 0.5% pectin correspond to variant 2 and the ones with 1% pectin correspond to variant 3.

FIG. 7A shows the firmness at day+14 obtained by a back-extrusion test of chilled and shelf-stable plant-based yogurt analogues without pectin (corresponding to variant 1) or with 1% pectin (corresponding to variant 3).

FIG. 7B shows the firmness at day+14 obtained by a back-extrusion test of chilled and shelf-stable plant-based yogurt analogues with pectin but without starch (corresponding to variant 3) or with both native starch and pectin (corresponding to variant 4).

FIG. 8 shows the firmness obtained by a back-extrusion test of chilled and shelf-stable coconut-based (variant 3) or almond-based (variant 5) yogurt analogues prepared with pea proteins. Shelf-stable yogurt analogues contain 1% pectin.

FIG. 9 shows the firmness at day+14 obtained by a back-extrusion test of chilled and shelf-stable plant-based yogurt analogue variant 1 (plain or with 14% mango, blueberry or raspberry fruit preparation).

### DETAILED DESCRIPTION OF THE INVENTION

As used in the specification, the words “comprise”, “comprising” and the like are to be construed in an inclusive sense, that is to say, in the sense of “including, but not limited to”, as opposed to an exclusive or exhaustive sense.

As used in the specification, the singular forms “a”, “an”, and “the” include plural referents unless the context clearly dictates otherwise.

As used in the specification, the term “substantially free” means that no more than 10 weight percent, preferably no more than 5 weight percent, and more preferably no more than 1 weight percent of the excluded material is present. In a preferred embodiment, “substantially free” means that no more than 0.1 weight percent of the excluded material remains. “Entirely free” typically means that at most only trace amount of the excluded material is present, and preferably, no detectable amount is present.

Unless noted otherwise, all percentages in the specification refer to weight percent, where applicable.

Unless defined otherwise, all technical and scientific terms have and should be given the same meaning as commonly understood by one of ordinary skill in the art to which this invention belongs.

The term “shelf-stable” refers to a food product having a shelf-life of at least three months at a temperature from 20° C. to 35° C., especially from 20° C. to 30° C.

The term “plant-based yogurt analogue” refers to a spoonable fermented edible food product which comprises ingredients of plant origin, which is free from dairy or soy ingredients, and which mimics the texture and the appearance of a dairy spoonable yogurt.

The term “hydrophilic liquid” refers to an edible liquid which comprises at least 70% of water. Especially, the hydrophilic is not derived from milk or soy. For example, milk, dairy creams or soy milk are excluded from this definition.

The term “animal component” refers to any ingredients, semi-finished products or finished products derived from an animal. It includes dairy component. Examples of animal component include fish, meat, blood, milk, egg, squid ink and ingredients derived thereof.

The term “dairy component” refers to any ingredients, semi-finished products or finished products derived from a non-human mammal milk. Examples of dairy components include whole milk, semi-skimmed milk, skimmed milk, milk powder, condensed milk, buttermilk, butter, cream, whey proteins, caseins, yogurts, ice-creams and mixtures thereof.

The term “soy component” refers to any ingredients, semi-finished products or finished products derived from soy. Examples of soy component include soy proteins, soybean milk, soy lecithin, soy cream, soy milk, soy yogurt, whole soybeans and mixtures thereof.

The term “pulse” refers to edible dried seeds of plants in the legume family. Pulses generally grow in pods and vary in terms of size, color & shape. The four most common pulses are beans, chickpeas, lentils and peas. Examples of lentils, as Lens Culinaris, include Beluga Lentils, Brown Lentils, French Green Lentils, Green Lentils and Red Lentils. Examples of beans, as Phaseolus Vulgaris, include Adzuki Beans, Anasazi Beans, Appaloosa Beans, Baby Lima Beans, Black Calypso Beans, Black Turtle Beans, Dark Red Kidney Beans, Great Northern Beans, Jacob's Cattle Trout Beans, Fava Beans, Large Lima Beans, Mung Beans, Pink Beans, Pinto Beans, Romano Beans, Scarlet Runner Beans, Tongue of Fire, White Kidney Beans and White Navy Beans. Examples of peas include Black-Eyed Peas, Green Peas, Marrowfat Peas, Pigeon Peas, Yellow Peas and Yellow-Eyed Peas. Examples of chickpeas, as Cicer Arietinum, include Chickpea and Kabuli.

The term “added thickening agents” refers to agents that increase the viscosity of a food product. They may also be used to protect the proteins and prevent their precipitation after a heat treatment. It includes gums, pectins, starches and the like. For avoidance of doubt, this definition excludes the plant proteins, fermentable sugar or hydrophilic liquid. It also excludes the naturally-occurring thickening agents that could be naturally present in the ingredients of the shelf-stable plant-based yogurt analogue.

The term “natural thickening agent” refers to a naturally-occurring thickening agent who has not been treated enzymatically, or chemically to change its properties. For avoidance of doubt, it includes naturally-occurring thickening agents that have been treated physically to change their properties.

In a first aspect, the invention relates to a process for preparing a shelf-stable plant-based yogurt analogue.

Especially, the shelf-stable plant-based yogurt analogue may be a shelf-stable plant-based set yogurt analogue, a shelf-stable plant-based Greek-style yogurt analogue, a shelf-stable plant-based strained yogurt analogue or a shelf-stable plant-based stirred yogurt analogue. More preferably, the shelf-stable plant-based yogurt is a shelf-stable plant-based stirred yogurt analogue. By “shelf-stable plant-based stirred yogurt analogue”, it is understood a shelf-stable plant-based yogurt analogue mimicking the texture of a stirred dairy yogurt.

Especially, the shelf-stable plant-based yogurt analogue is free from any dairy components. More generally, the shelf-stable plant-based yogurt analogue is preferably free from any animal components. In addition, the shelf-stable plant-based yogurt analogue is free from soy components. Indeed, soy & its derivatives (e.g. soy milk) are avoided by consumers due to the potential presence in soy plant materials of antinutrient factors (e.g. phytic acid), molecules considered as endocrine disruptors (e.g. phytoestrogens, isoflavones) or even due to their potential GMO origin.

In a first step, the process comprises a step of providing a plant-based food composition. Especially, the plant-based food composition comprises a hydrophilic liquid, a non-dairy fermentable sugar, and plant proteins. Said plant-based food composition comprises from 3.5 wt % to 6.0 wt % of plant proteins and is free from soy and dairy components.

In a particular embodiment, the plant-based food composition is provided as a plant-based raw material or a plant-based premix already containing a hydrophilic liquid, a fermentable sugar, and plant proteins. By “plant-based raw material”, it is understood a crude or processed materials of plant origin which are staple materials to manufacture food products (e.g. coconut milk). A plant-based raw material shall not be a soy component or a dairy component. Preferably, the plant-based raw material shall not be an animal component. By “plant-based premix”, it is understood a composition prepared before its use by mixing raw materials, especially plant-based raw materials, and such a composition does not contain any soy components or dairy components. Preferably, such a composition does not contain an animal component. It is also preferred that such plant-based raw materials or plant-based premixes comprise from 3.5 wt % to 6.0 wt % of plant proteins.

In an alternative embodiment, the plant-based food composition is prepared by mixing a hydrophilic liquid, a fermentable sugar, and plant proteins such that the plant-based food composition comprises from 3.5 wt % to 6.0 wt % of plant proteins. The food composition may be prepared by mixing additional ingredients (e.g. vitamins, minerals, oil, fibres . . . ) to the ones previously cited, provided that these additional ingredients are not or does not comprise dairy components or soy components. Preferably, the additional ingredient are not or does not comprise animal components. It is also preferred that the plant-based food composition is prepared such that the fermentable sugar(s), the plant proteins and the potential additional ingredient(s) are mixed together at their targeted concentrations and such that the plant-based food composition is complemented with the hydrophilic liquid(s) to reach 100 wt %. In this embodiment, the plant protein is provided via a plant protein preparation. A plant protein preparation is a composition comprising from 30.0 wt % to 95.0% of plant proteins. In a preferred embodiment, the plant protein preparation is a plant protein concentrate. The term “plant protein concentrate” refers to a composition comprising a non-soy plant protein content from 60% to 80%. In a more preferred embodiment, the plant protein preparation is a plant protein isolate. The term “plant protein isolate” refers to a composition comprising a non-soy plant protein content from 80.0% to 95.0%.

Details about the plant-based food composition and its components are provided below.

The plant-based food composition comprises a hydrophilic liquid. The hydrophilic liquid may be water, non-soy plant-based liquids or mixtures thereof. By “non-soy plant-based liquids”, it is understood a non-dairy liquid composition, which may be a viscous liquid composition such as a cream, which is derived from an edible plant source (e.g. fruits, grains, nuts, pulses, seeds and the like) different from soy. The non-soy plant-based liquid may be a plant-based cream alternative, plant-based milk alternative, plant-based water and mixtures thereof. Examples of plant-based cream alternative include almond cream, cashew cream, coconut cream, hazelnut cream, peanut cream and mixtures thereof. Examples of plant-based milk alternative include almond milk, banana milk, cashew milk, chestnut milk, coconut milk, hazelnut milk, flaxseed milk, hemp seed milk, lupine milk, oat milk, peanut milk, pine nut milk, pistachio milk, rice milk, sesame seed milk, sunflower seed milk, walnut milk and mixtures thereof. Examples of plant-based water include coconut water. Preferably, the hydrophilic liquid is water or a plant-based milk alternative. More preferably, the plant-based milk alternative is selected from the group consisting of almond milk, cashew milk, coconut milk, hazelnut milk, oat milk, peanut milk and mixtures thereof. The hydrophilic liquid contributes to improve the nutritional profile and/or the organoleptic profile of the shelf-stable yogurt analogue.

The plant-based food composition comprises a fermentable sugar. By “fermentable sugar”, it is understood sugars of non-dairy origin, which are converted into acids upon fermentation by starter cultures. Lactose is excluded from this definition. The acid formation will promote the formation of a gel with a sufficient consistency by the coagulation of plant proteins into a plant protein network. The consistency of the obtained gel mimics the consistency of standard spoonable dairy yogurts. Examples of fermentable sugar include agave syrup, brown sugar, coconut sugar, corn syrup, dextrose, fructose, glucose, honey, invert sugar, maltose, molasse, sucrose, and mixtures thereof. In a preferred embodiment, the fermentable sugar is sucrose.

In a preferred embodiment, the plant-based food composition comprises from 3 wt % to 10 wt % of fermentable sugar. Such a range guarantees an effective fermentation (i.e. low fermentation time to reach the targeted pH) and a good nutritional profile (i.e. not too high sugar content) at the same time. More preferably, the plant-based food composition comprises from 3 wt % to 8 wt % of fermentable sugar. More preferably, the plant-based food composition comprises from 4 wt % to 6 wt % of fermentable sugar. Most preferably, the plant-based food composition comprises 5 wt % of fermentable sugar.

The plant-based food composition comprises plant proteins. The term “plant proteins” refers to edible proteins originated from plant materials, which are different from soy. Especially, soy proteins are excluded from the scope of the invention. Indeed, as previously explained, soy and its derivatives (e.g. soy proteins) are avoided by consumers for the abovementioned reasons. The plant proteins of the invention shall coagulate and shall form a gel upon acidification, especially upon fermentation. Indeed, the formation of a gel increases the viscosity of the final product and in the end, it enables to reach a range of textures that mimic the textures of standard dairy yogurts. Hence, a satisfactory texture may be reached without the addition of any added thickening agents, said added thickening agents being avoided by consumers. Moreover, plant proteins are key on a nutritional standpoint. They substitute dairy proteins as a source of amino acids within the yogurt analogue.

The plant-based food composition comprises from 3.5 wt % to 6.0 wt % of plant protein, preferably from 3.5 wt % to 5.0 wt %, even more preferably from 4.5 wt % to 5.0 wt %. Without wishing to be bound by theory, this range of amount of plant proteins enables to reach a satisfactory texture upon acid gelation of plant proteins while minimizing the risk of protein precipitation. Indeed, below this range, the plant proteins would not form a satisfactory gel upon acidification, or even not form any gel. Above this range, the plant proteins would precipitate upon the second heat-treatment and the shelf-stable plant-based yogurt analogue would exhibit an unpleasant grainy/gritty texture in mouth. In addition, this range of amount of plant proteins ensures an acceptable level of proteins for nutritional purposes.

In particular the plant-based food composition comprises 3.5 wt %, 3.6 wt %, 3.7 wt %, 3.8 wt %, 3.9 wt %, 4.0 wt %, 4.1 wt %, 4.2 wt %, 4.3 wt %, 4.4 wt %, 4.5 wt %, 4.6 wt %, 4.7 wt %, 4.8 wt %, 4.9 wt %, 5.0 wt %, 5.1 wt %, 5.2 wt %, 5.3 wt %, 5.4 wt %, 5.5 wt %, 5.6 wt %, 5.7 wt %, 5.8 wt %, 5.9 wt %, 6.0 wt % of plant proteins. The obtained shelf-stable plant-based yogurt analogue has a texture mimicking the texture of standard spoonable dairy yogurts, more preferably stirred dairy yogurts.

In a more preferred embodiment, the shelf-stable plant-based yogurt analogue is a shelf-stable plant-based stirred yogurt analogue and it comprises from 3.5 wt % to 6.0 wt % of plant proteins.

In a preferred embodiment, plant proteins are pulse proteins. Indeed, pulse proteins are preferred for the invention because they form a satisfactory gel upon acidification. Hence, upon acidification, pulse proteins can provide a range of textures that can mimic the texture of dairy yogurts, more preferably stirred dairy yogurts. More preferably, pulse proteins are selected from the group consisting of bean proteins, chickpea proteins, fava bean proteins, lentil proteins, pea proteins, and mixtures thereof. Preferably, the pulse proteins are selected from the group consisting of fava bean proteins, pea proteins and a combination thereof.

In a more preferred embodiment, pulse proteins are pea proteins. Pea proteins are the proteins that provide the most satisfactory results in terms of gelation upon acidification. Pea proteins, at a predetermined content and upon acid gelation, enable to perfectly mimic the texture of dairy yogurts while providing reduced off-notes. In addition, the advantage of pea proteins compared to other pulse proteins is the wide availability of pea protein isolates from providers. For most of the pulse proteins, protein isolates are not available yet.

In an alternative embodiment, the plant proteins may be chosen from the group consisting of almond proteins, cashew proteins, hemp proteins, nut proteins, oat proteins, rice proteins, wheat proteins and mixtures thereof.

In a preferred embodiment, the plant-based food composition comprises a total protein content of at most 6.0 wt %, preferably of at most 5.5 wt % or of at most 5.0 wt %. This protein content limits the precipitation of proteins upon heat-treatment. This results in a plant-based yogurt analogue which is smooth in mouth and which does not exhibit an unpleasant grainy/gritty texture.

In a further embodiment, the plant-based food composition comprises a fat content from 2.5 wt % to 12.0 wt %. Preferably, the fat content ranges from 2.5 wt % to 10.0 wt %, from 2.5 wt % to 5.0 wt % or from 3.0 wt % to 4.0 wt %. Most preferably, the fat content is of 3.5 wt %. In a preferred embodiment, the fat content consists essentially of vegetable fat. By “vegetable fat”, it is understood fat of non-soy plant origin. The vegetable fat content may participate in collaboration with the proteins to the texture of the final food product, especially by improving mouthfeel of the shelf-stable plant-based yogurt analogue.

In an additional embodiment, the plant-based food composition has a dry matter from 11 wt % to 15 wt %, preferably from 13 wt % to 15 wt %. More preferably, the dry matter is of 13.7 wt %. The dry matter, including the protein content, participates in the texture of the shelf-stable plant-based yogurt analogue.

In another embodiment, the plant-based food composition may further comprise algae flours, antioxidants, colours, edible plant oils, fibres, flavours, flower essences, fruits, minerals, prebiotics, sauces, solid inclusions, spices, sweeteners, tea, vegetables and/or vitamins. The only condition is that these ingredients shall not be or shall not comprise a soy components or a dairy components. More preferably, these ingredients shall not be or shall not comprise animal components.

After providing the plant-based food composition, the process of the invention comprises a step of homogenizing the plant-based food composition at a pressure from 50 bar to 700 bar. Preferably, the homogenizing step is performed at a pressure from 50 bar to 500 bar. More preferably, the homogenizing step is performed at a pressure from 50 to 300 bar, from 100 to 300 bar or from 150 to 300 bar. Most preferably, the homogenizing step is performed at a pressure of 200 bar. Without wishing to be bound by theory, it is believed that the homogenizing step is an important step to functionalize the plant proteins. Indeed, the obtaining of a self-supporting gel resulting from the coagulation of plant proteins is only possible after performing a homogenizing step. In the absence of homogenization step, the plant proteins would not provide, upon acidification, a self-supporting gel which has a satisfactory texture. Especially, a satisfactory texture mimicking the texture of standard dairy yogurts, would not be reached.

In a preferred embodiment, the homogenization step is performed at a temperature from 50° C. to 70° C. More preferably, the homogenization step is performed at a temperature from 55° C. to 65° C. Most preferably, the homogenization step is performed at a temperature of 60° C.

After the homogenization step, the process according to the invention comprises a step of heat-treating the plant-based food composition at a temperature from 80° C. to 100° for 1 minute to 10 minutes. Preferably, the heat treatment is performed at a temperature from 85° C. to 95° C. for 3 minutes to 7 minutes. Preferably, the heat treatment is performed at a temperature of 92° C. for a time of 6 minutes. The heat treatment step is performed for hygiene and quality purposes. Indeed, this heat treatment prevents any development of unwanted micro-organisms in the plant-based yogurt analogue, such as bacteria or moulds that may affect negatively the organoleptic properties of the plant-based yogurt analogue, or that may be pathogenic. Moreover, without wishing to be bound by theory, it is believed that this heat treatment also participates in the functionalization of the plant proteins but to a lesser extent than the homogenization step. In particular it has been found that the heat treatment step participates to a certain extent in enhancing the gelling properties of plant proteins upon acidification. For example, the heat-treatment may be carried out in an indirect manner by means of a heat-plate exchanger. As a variant, it is possible to carry it out in a jacketed holding unit.

The heat-treatment step may be performed prior or after the homogenization step. In a preferred embodiment, the heat-treatment is performed after the homogenization step. Indeed, for hygienic and manufacturing purposes, it is preferred that the heat-treatment is performed after the homogenization step. Indeed, it ensures the elimination of any unwanted micro-organisms that could be brought during the homogenization step, especially in the event where the homogenization step is performed with a non-aseptic homogenizing equipment. Moreover, in the event where the homogenization step is performed with a non-aseptic homogenizing equipment and is performed after the heat-treatment step, it would require to perform an additional heat-treatment after the homogenizing step. Such an additional heat-treatment makes the process more complex to be implemented. Moreover, it is desired to minimize the number of heat-treatments as heat-treatments may negatively impact the nutritional composition and sensory profile of the final product.

After the first heat-treatment step, the process comprises a step of inoculating the heat-treated and homogenized plant-based food composition with at least one starter culture.

Especially, the starter culture is substantially free, preferably entirely free from dairy components or soy components. Examples of starter culture include Lactobacillus acidophilus, Lactobacillus delbrueckii subsp. bulgaricus, Lactobacillus paracasei, Lactobacillus casei, Lactobacillus johnsonii, Lactobacillus plantarum, Streptococcus thermophilus, Streptococcus lactis, Streptococcus cremoris, Bacillus coagulans, strains from the genus Bifidobacterium and mixtures thereof. Preferably, the starter culture consists of one or more lactic acid bacteria strains. Preferably, the starter culture consists of one or more thermophilic lactic acid bacteria strains. The term “thermophilic lactic acid bacteria strains” refers to lactic acid bacteria strains having an optimal growth at a temperature between 36° C. and 45° C. Most preferably, the starter culture is a combination of Lactobacillus delbrueckii subsp. bulgaricus and Streptococcus thermophilus. Especially, Lactobacillus delbrueckii subsp. bulgaricus and Streptococcus thermophilus are the two staple strains that are used in dairy yogurts. According to certain regulation, the yogurt denomination is only possible for dairy yogurt containing said two strains as starter cultures. Hence, by using these strains, the yogurt analogue even more mimics dairy yogurts.

After the inoculation step, the process according to the invention comprises a step of fermenting inoculated plant-based food composition until reaching a pH from 4.5 and 6.2, preferably 4.5 to 5.0, to obtain a plant-based yogurt analogue. During the fermentation step, the starter culture converts the fermentable sugar into acids. The formation of acids promotes the formation of a gel with a sufficient consistency by the coagulation of plant proteins into a plant protein network. The consistency of the obtained gel mimics the consistency of standard dairy yogurts. A satisfactory texture is obtained even in the absence of added thickening agents.

It has been found that fermentation is key to form a satisfactory flavor profile but also satisfactory texture, even in the absence of any added thickening agents. Indeed, without wishing to be bound by theory, fermentation leads to a non-linear and progressive acidification which is conducive to the formation of a plant protein network. Moreover, upon fermentation, the starter culture produces exopolysaccharides (EPS). The formation of a plant protein network and the production of EPS upon fermentation contribute to the achievement of a satisfactory yogurt-like texture. Without wishing to be bound by theory, this would not be achieved with acidification by simple addition of an organic acid, such as citric acid. Indeed, the acidification by addition of organic acids is not progressive and does not produce any EPS. Hence, it is not expected to provide the same satisfactory texture properties, including consistency, as the ones achieved through fermentation. In addition, the acidification by addition of an organic acid is not expected to provide a taste as satisfactory as that achieved through fermentation. Indeed, fermentation leads to the generation of a combination of organic acids (e.g. lactic acid) and other flavour molecules that contribute to provide a pleasant flavor profile which cannot be achieved by simple addition with an organic acid.

In a further embodiment, the fermentation step is performed at the temperature of optimal growth of the starter culture. The temperature of optimal growth of the starter culture may be easily determined by the person skilled in the art. Preferably, the fermentation step is performed at temperature from 25° C. and 45° C. More preferably, the fermentation step is performed at a temperature from 36° C. to 45° C. Most preferably, the fermentation step is performed at 43° C.

The process of the invention comprises a second heat treatment after the fermentation step. Especially, the process comprises a step of heat treating the plant-based yogurt analogue at a temperature from 80° C. to 110° C. for 5 seconds to 90 seconds to obtain a shelf-stable plant-based yogurt analogue. Preferably, the heat treatment is performed at a temperature from 80° C. to 100° C. for 5 seconds to 90 seconds. More preferably, the heat treatment is performed at a temperature from 80° C. to 100° C. for 30 seconds to 90 seconds. Most preferably, the heat treatment is performed at a temperature from 85° C. to 95° C. for 35 seconds to 90 seconds, even most preferably from 88° C. to 93° C. for 35 seconds to 90 seconds. Most preferably, the heat treatment is performed at a temperature of 90° C. for a time of 60 seconds.

The second heat treatment enables to considerably extend the shelf-life of the shelf-stable plant-based yogurt analogue, especially the shelf-life is extended to at least 3 months and the product may be stored at ambient temperatures (i.e. between 20° C. to 35° C.) without involving sanitary risks. In particular, heat-treatment with temperature and/or time conditions which are lower to the ranges provided above for the second heat treatment may not enable to reach a satisfactory safety, hygienic and sanitary level to enable its storage under ambient conditions. The obtained shelf-stable plant-based yogurt analogue is more convenient for the consumer than a chilled plant-based yogurt analogue. Indeed, the shelf-stable plant-based yogurt analogue may be safely taken away or stored in shelves without the need of a cold storage at a temperature between 1° C. and 10° C.

It is known for dairy yogurts that the protein network formed after fermentation is very sensitive, especially sensitive to heat treatment, such as above-mentioned heat-treatment conditions. The person skilled in the art knows that applying a heat treatment after fermentation often leads, in dairy yogurts, to an undesirable precipitation of the proteins and leads to a significant loss of texture. The loss of texture may lead to an unsatisfactory texture, especially, a texture far from which can be expected for yogurts. The precipitation of proteins generates an unpleasant grainy/gritty texture in mouth and in certain case, to an unattractive aspect by the appearance of grains into the yogurt. To avoid the foregoing, added thickening agents may be used, in dairy yogurts, before the heat treatment to compensate the loss of texture and to protect the proteins from the second heat treatment.

Surprisingly, it has been found that a second treatment after fermentation does not lead to a precipitation of the plant proteins. This is even the case in presence of a significant amount of plant proteins (i.e. above 3.5 wt. %). Moreover, despite a loss of texture, a shelf-stable plant-based yogurt analogue having a satisfactory texture may be achieved, even in the absence of any added thickening agents.

Thanks to the second heat treatment after fermentation, the shelf-stable plant-based yogurt analogue has a shelf-life of at least 3 months at a temperature of 20° C. to 35° C., preferably of 20° C. to 30° C. In another embodiment, the shelf-stable plant-based yogurt analogue has a shelf-life of 3 months, 6 months, 9 months, 12 months, 15 months, 18 months, 24 months or even 36 months at a temperature of 20° C. to 35° C., preferably of 20° C. to 30° C. In another embodiment, the shelf-stable plant-based yogurt analogue has a shelf-life of at least 3 months at a temperature of 20° C. to 35° C., preferably of 20° C. to 30° C. and at a relative humidity of 60% to 75%. In another embodiment, the shelf-stable plant-based yogurt analogue has a shelf-life of at least 3 months, 6 months, 9 months, 12 months, 15 months, 18 months, 24 months or even 36 months at a temperature of 20° C. to 35° C., preferably of 20° C. to 30° C. and at a relative humidity of 60% to 75%. The relative humidity may be measured with a hygrometer, for example a psychometrer or a wet-and-dry-bulb thermometer.

The shelf-stable plant-based yogurt analogue has a texture (i.e. firmness and viscosity) mimicking the texture of standard spoonable dairy yogurts.

In a further embodiment, the shelf-stable plant-based yogurt analogue has a firmness of at least 35 g at 8° C., preferably of at least 35 g at 8° C., of at least 40 g at 8° C., of at least 50 g at 8° C., of at least 60 g at 8° C. or of at least 70 g at 8° C. In a preferred embodiment, the shelf-stable plant-based yogurt analogue has a firmness ranging from 40 g to 65 g at 8° C.

The firmness is measured at 1 day after fermentation on 30 g samples of the shelf-stable plant-based yogurt analogue. First, the sample of the fermented food product is stored at a temperature of 10° C. for a minimum of 2 hours prior to measurement. Then, the firmness is measured through pseudo compression test using a texturometer, preferably TAX-T2 Texture Analyzer (TA instruments, Stable Micro Systems, UK), with 30 mm diameter cylindrical flat probe penetrating into the samples at a crosshead speed of 0.5 mm·s⁻¹ and to depth of 30 mm.

In another embodiment, the shelf-stable plant-based yogurt analogue has a viscosity of at least 0.4 Pa·s at 60 s⁻¹ at 10° C., preferably of at least 0.5 Pa·s at 60 s⁻¹ at 10° C. or of at least 0.7 Pa·s at 60s⁻¹ at 10° C. Especially, the shelf-stable plant-based yogurt analogue has a viscosity ranging from 0.4 Pa·s to 1.1 Pa·s, preferably from 0.7 Pa·s to 1.1 Pa·s at 60 s⁻¹ at 10° C. The viscosity is measured at 1 day after fermentation on 30 g of sample of the shelf-stable plant-based yogurt analogue. First, the sample of the shelf-stable plant-based yogurt analogue is stored at a temperature of 10° C. for a minimum of 2 hours prior to measurement. Then, the sample is gently stirred in a circular motion 3 times before transferring to a standard cylindrical sample holder of a rheometer, preferably Physica MCR 101 rheometer (Anton Paar GmbH, Graz, Austria), with coaxial cylinders. Viscosity is measured using RheoPlus software (Anton Paar GmbH, Graz, Austria) in terms of Pa*s at 60⁻¹ at 10° C.

In a further embodiment, the shelf-stable plant-based yogurt analogue has a mean protein particle size ranging from 1 μm to 70 μm, preferably ranging from 1 μm to 60 μm, more preferably ranging from 1 μm to 50 μm. At such ranges of mean protein particle size, the texture of the shelf-stable plant-based yogurt analogue is not grainy/gritty but smooth in mouth. Especially, there is no or limited precipitation of the plant proteins after the second heat treatment. In case of significant plant protein precipitation, the shelf-stable plant-based yogurt analogue would have a mean protein particle size significantly higher than 70 μm.

The mean protein particle size of the shelf-stable plant-based yogurt analogue is measured by means of a laser diffraction analyzer (MasterSizer, Malvern Instruments Ltd., UK), applying the Fraunhofer optical model. Especially, the mean protein particle size is measured at room temperature with a refractive index of 1.5. The term “room temperature” relates to the normal temperature of a room, especially it means about 20° C. to about 25° C., preferably about 25° C. The shelf-stable plant-based yogurt analogue is substantially free, preferably entirely free, from any added thickening agents.

In another embodiment, the process does not comprise any step consisting in the addition of any added thickening agents. Examples of added thickening agents include acacia gum, agar, alginate, carrageenan, gelatin, gellan, locust bean gum, pectin, starch, xanthan gum, and mixtures thereof. In the present context, the term “starch” includes ingredients consisting only of starch but also includes starch-containing flours. In particular, the process does not comprise any step consisting in the addition of any added thickening agents selected from the list consisting of acacia gum, agar, alginate, carrageenan, gelatin, gellan, locust bean gum, pectin, starch, xanthan gum and mixtures thereof. In particular the shelf-stable plant-based yogurt analogue is substantially free, preferably entirely free from any added thickening agents. In particular, the shelf-stable plant-based yogurt analogue is substantially free, preferably entirely free from any added thickening agents selected from the list consisting of acacia gum, agar, alginate, carrageenan, gelatin, gellan, locust bean gum, pectin, starch, xanthan gum and mixtures thereof. Surprisingly, despite the second heat treatment, the shelf-stable plant-based yogurt analogue has a satisfactory smooth and thick texture and no protein precipitation is observed, even in the absence of any added thickening agent.

In an alternative embodiment, the process further comprises after the fermentation (step (e)) and prior to the second heat treatment (step (f)), the addition of at least one natural thickening agent to the plant-based yogurt analogue. Even if the texture of the final product is satisfactory without any added thickening agents, natural thickening agents may be added to obtain thicker textures without increasing the protein content of the shelf-stable plant-based yogurt analogue. Even if protein precipitation is not observed after the second heat-treatment, natural thickening agents may also be added to protect plant proteins and prevent their precipitation at very high temperatures. Preferably, the natural thickening agent is added just before the plant-based yogurt analogue is smoothed. The smoothing step enables to ensure a good incorporation of the thickening agent and maximize its thickening and protective properties. Preferably, the natural thickening agent is pectin. It has been found that pectin is able to slightly increase the texture of the final food product and protect plant proteins from precipitation after the second heat treatment. The protective effect of pectin is not as effective when pectin is added in the initial plant-based food composition at step a). In a more preferred embodiment, the natural thickening agent is high methoxyl pectin. In a most preferred embodiment, the natural thickening agent is citrus high methoxyl pectin. The term “high methoxyl pectin” is a pectin having a degree of esterification (DE) of at least 50%, preferably from 55% to 75%. The degree of esterification (DE) is defined as the number of methyl-esterified galacturonic acid units expressed as a percentage of the total galacturonic acid units in the pectin molecule.

In a further embodiment, the plant-based food composition of step a) may further comprise at least one natural thickening agent. Preferably, the natural thickening agent is a native starch. The term “native starch” refers to a naturally-occurring starch which has not been enzymatically or chemically treated to change its properties. For avoidance, the term “native starch” comprises naturally-occurring starch which has been physically treated to change its properties. Even if a satisfactory texture is achieved without any thickening agent, the addition of native starch enables to significantly improve the texture of the shelf-stable plant-based yogurt analogue. Especially, the addition of native starch enables to compensate the texture loss in the final yogurt analogue due to the second heat treatment after fermentation.

In a further embodiment, the shelf-stable plant-based yogurt analogue comprises from 0.4 wt % to 2.0 wt % of natural thickening agent. Preferably, the shelf-stable plant-based yogurt analogue comprises from 0.4 wt % to 1.5 wt %, from 0.5 wt % to 1.5 wt % or from 0.5 wt % to 1.0 wt % of natural thickening agent.

In a particular embodiment, the shelf-stable plant-based yogurt analogue comprises from 0.4 wt % to 1 wt % of pectin and/or comprises from 0.5 wt % to 1 wt % of native starch.

Preferably, the shelf-stable spoonable plant-based yogurt analogue comprises 1 wt % of pectin and/or 0.9 wt % of native starch. Preferably, the pectin is a high methoxyl pectin. More preferably, the pectin is a citrus high methoxyl pectin.

In a further embodiment, the shelf-stable plant-based yogurt analogue comprises a fat content from 2.5 wt % to 12 wt %. Preferably, the fat content ranges from 2.5 wt % to 10 wt % or from 3 wt % to 5 wt %. Most preferably, the fat content is of 3.5 wt %. In a preferred embodiment, the fat content consists essentially of vegetable fat.

In a further embodiment, the shelf-stable plant-based yogurt analogue has a dry matter from 11 wt % to 15 wt %, preferably from 13 wt % to 15 wt %. More preferably, the dry matter is of 13.7 wt %. The dry matter, including the protein content, participates in the texture of the final yogurt analogue.

The process may further comprise a step of mixing the shelf-stable plant-based yogurt analogue with additional ingredients such as antioxidants, algae flours, antioxidants, cocoa, colours, edible plant oils, fibres, flavours, flower essences, fruits, fruit preparations, minerals, prebiotics, probiotics, sauces, solid inclusions, spices, sweeteners, vegetables and/or vitamins.

For the avoidance of doubt, analogously to the plant-based food composition and to the plant-based yogurt analogue, the shelf-stable plant-based yogurt analogue comprises a hydrophilic liquid, a fermentable sugar, and plant proteins. Especially, the shelf-stable plant-based yogurt analogue comprises from 2.0 wt % to 6 wt % of plant proteins, preferably from 3.5 to 6 wt %, more preferably from 4.0 wt % to 5.0 wt %, or even more preferably from 4.5 wt % to 5.0 wt % and is free from and it is free from soy and dairy components Especially, in a preferred embodiment, the shelf-stable plant-based yogurt analogue comprises a total protein content of at most 6.0 wt %, preferably of at most 5.5 wt % or of at most 5.0 wt %. This protein content limits the precipitation of proteins upon heat-treatment. This results in a plant-based yogurt analogue which is smooth in mouth and which does not exhibit an unpleasant grainy/gritty texture.

In a second aspect, the invention relates to a shelf-stable plant-based yogurt analogue obtained according to the process of the first aspect of the invention. The features of the shelf-stable plant-based yogurt analogue according to the third aspect of the invention listed herein below are applicable to the shelf-stable plant-based yogurt analogue according to this second aspect of the invention.

In a third aspect, the invention relates to a shelf-stable plant-based yogurt analogue.

In a preferred embodiment, the shelf-stable plant-based yogurt analogue may be a shelf-stable plant-based set yogurt analogue, a shelf-stable plant-based Greek-style yogurt analogue, a shelf-stable non plant-based strained yogurt analogue or a shelf-stable plant-based stirred yogurt analogue. More preferably, the shelf-stable plant-based yogurt analogue is a shelf-stable plant-based stirred yogurt analogue.

The shelf-stable plant-based yogurt analogue is free from soy components and dairy components. More generally, the shelf-stable plant-based yogurt analogue is preferably free from any animal components.

The shelf-stable plant-based yogurt analogue comprises a hydrophilic liquid. Details about and examples of hydrophilic liquid are disclosed in the first aspect of the invention. The hydrophilic liquid contributes to improve the nutritional profile and/or the organoleptic profile of the shelf-stable plant-based yogurt analogue. In a further embodiment, the shelf-stable plant-based yogurt analogue comprises from 40 wt % to 95 wt %, preferably from 50 to 95 wt % or 60 to 95 wt % of hydrophilic liquid.

The shelf-stable plant-based yogurt analogue comprises a fermentable sugar. The fermentable sugar is converted into acid by the starter culture during the fermentation step. The acid formation will promote the formation of a gel with a sufficient consistency by the coagulation of plant proteins into a plant protein network. The consistency of the obtained gel mimics the consistency of standard dairy yogurts. Examples of fermentable sugar include agave syrup, brown sugar, coconut sugar, corn syrup, dextrose, fructose, glucose, honey, invert sugar, maltose, molasse, sucrose, and mixtures thereof. In a preferred embodiment, the fermentable sugar is sucrose.

In a further embodiment, the shelf-stable plant-based yogurt analogue comprises from 3 wt % to 10 wt % of fermentable sugar. Such a range guarantees an effective fermentation (i.e. low fermentation time to reach the targeted pH) and a good nutritional profile (i.e. not too high sugar content) at the same time. More preferably, the shelf-stable plant-based yogurt analogue comprises from 3 wt % to 8 wt % of non-dairy fermentable sugar. More preferably, shelf-stable plant-based yogurt analogue comprises from 4 wt % to 6 wt % of fermentable sugar. Most preferably, the shelf-stable plant-based yogurt analogue comprises 5 wt % of fermentable sugar.

The shelf-stable plant-based yogurt analogue comprises plant proteins. The plant proteins of the invention shall coagulate and form a gel upon acidification, especially upon fermentation. Indeed, the formation of gel increases the viscosity of the final product and in the end, it enables to reach a range of textures that mimic the textures of standard spoonable dairy yogurts. Moreover, plant proteins are key on a nutritional standpoint. They substitute dairy proteins as a source of amino acids.

The shelf-stable plant-based yogurt analogue has from 3.5 wt % to 6.0 wt % of plant proteins, preferably from 4.0 wt % to 5.0 wt %, or even more preferably from 4.5 wt % to 5.0 wt %.

Without wishing to be bound by theory, this range of proteins enable to reach a satisfactory texture upon acid gelation of proteins while minimizing the risk of protein precipitation. Indeed, below this range, the plant proteins would not form a satisfactory gel upon acidification. Over this range, the plant proteins would precipitate upon the second heat-treatment and the shelf-stable plant-based yogurt analogue would exhibit an unpleasant grainy/gritty texture in mouth. In addition, this range of proteins ensures an acceptable level of proteins for nutritional purposes.

In particular, the shelf-stable plant-based yogurt analogue comprises 3.5 wt %, 3.6 wt %, 3.7 wt %, 3.8 wt %, 3.9 wt %, 4.0 wt %, 4.1 wt %, 4.2 wt %, 4.3 wt %, 4.4 wt %, 4.5 wt %, 4.6 wt %, 4.7 wt %, 4.8 wt %, 4.9 wt %, 5.0 wt %, 5.1 wt %, 5.2 wt %, 5.3 wt %, 5.4 wt %, 5.5 wt %, 5.6 wt %, 5.7 wt %, 5.8 wt %, 5.9 wt %, 6.0 wt % of plant proteins.

In a preferred embodiment, the plant proteins are pulse proteins. The advantages of using pulse proteins are presented in the first aspect of the present invention. Preferably the pulse proteins are selected from the group consisting of bean proteins, chickpea proteins, fava bean proteins, lentil proteins, pea proteins, and mixtures thereof. Preferably, the pulse proteins are selected from the group consisting of fava bean proteins, pea proteins and a combination thereof.

In a more preferred embodiment, the pulse proteins are pea proteins. The advantages of using pea proteins are presented in the first aspect of the present invention. In an alternative embodiment, the plant proteins may be chosen from the group consisting of almond proteins, cashew proteins, hemp proteins, nut proteins, oat proteins, rice proteins, wheat proteins and mixtures thereof.

In a preferred embodiment, the shelf-stable plant-based yogurt analogue comprises a total protein content of at most 6.0 wt %, preferably of at most 5.5 wt % or of at most 5.0 wt %. This protein content limits the precipitation of proteins upon heat-treatment. This results in a plant-based yogurt analogue which is smooth in mouth and which does not exhibit an unpleasant grainy/gritty texture.

The shelf-stable plant-based yogurt analogue has a pH of 4.5 to 6.2, preferably of 4.5 to 5.0. This pH results from the fermentation of the fermentable sugars and possible other fermentable compounds by the starter culture(s).

The shelf-stable plant-based yogurt analogue has a shelf-life of at least 3 months at a temperature of 20° C. to 35° C., preferably of 20° C. to 30° C.

In another embodiment, the shelf-stable plant-based yogurt analogue has a shelf-life of 3 months, 6 months, 9 months, 12 months, 15 months, 18 months, 24 months or even 36 months at a temperature of 20° C. to 35° C., preferably of 20° C. to 30° C. In another embodiment, the shelf-stable plant-based yogurt analogue has a shelf-life of at least 3 months at a temperature of 20° C. to 35° C., preferably of 20° C. to 30° C. and at a relative humidity of 60% to 75%. In another embodiment, the shelf-stable plant-based yogurt analogue has a shelf-life of at least 3 months, 6 months, 9 months, 12 months, 15 months, 18 months, 24 months or even 36 months at a temperature of 20° C. to 35° C., preferably of 20° C. to 30° C. and at a relative humidity of 60% to 75%. The relative humidity may be measured with a hygrometer, for example a psychometrer or a wet-and-dry-bulb thermometer.

The shelf-stable plant-based yogurt analogue has a texture mimicking the texture of standard spoonable dairy yogurts, preferably stirred dairy yogurts.

In a further embodiment, the shelf-stable plant-based food yogurt analogue has a firmness of at least 35 g at 8° C., preferably of at least 40 g at 8° C., of at least 50 g at 8° C., of at least 60 g at 8° C., of at least 70 g at 8° C. In a preferred embodiment, the shelf-stable plant-based yogurt analogue has a firmness ranging from 40 g to 65 g at 8° C.

The firmness is measured at 1 day after fermentation on 30 g samples of the shelf-stable plant-based yogurt analogue. First, the sample of the fermented food product is stored at a temperature of 10° C. fora minimum of 2 hours prior to measurement. Then, the firmness is measured through pseudo compression test using a texturometer, preferably TAX-T2 Texture Analyzer (TA instruments, Stable Micro Systems, UK), with 30 mm diameter cylindrical flat probe penetrating into the samples at a crosshead speed of 0.5 mm·s⁻¹ and to depth of 30 mm.

In another embodiment, the shelf-stable plant-based yogurt analogue has a viscosity of at least 0.4 Pa·s at 60 s⁻¹ at 10° C., preferably of at least 0.5 Pa·s at 60 s⁻¹ at 10° C. or of at least 0.7 Pa·s at 60s⁻¹ at 10° C. Especially, shelf-stable plant-based yogurt analogue has a viscosity ranging from 0.4 Pa·s to 1.1 Pa·s, preferably from 0.7 Pa·s to 1.1 Pa·s at 60 s⁻¹ at 10° C.

The viscosity is measured at 1 day after fermentation on about 30 g of sample of the shelf-stable plant-based yogurt analogue. First, the sample of the shelf-stable plant-based yogurt analogue is stored at a temperature of 10° C. for a minimum of 2 hours prior to measurement. Then, the sample is gently stirred in a circular motion 3 times before transferring to a standard cylindrical sample holder of a rheometer, preferably Physica MCR 101 rheometer (Anton Paar GmbH, Graz, Austria), with coaxial cylinders. Viscosity is measured using RheoPlus software (Anton Paar GmbH, Graz, Austria) in terms of Pa*s at 60-1 at 10° C.

In a further embodiment, the shelf-stable plant-based yogurt analogue has a mean protein particle size ranging from 1 to 70 μm, preferably ranging from 1 to 60 μm, more preferably ranging from 1 to 50 μm. At such ranges of mean protein particle size, the texture of the shelf-stable plant-based yogurt analogue is not grainy/gritty but smooth in mouth. Especially, there is no or limited precipitation of the non-soy plant proteins after the second heat treatment. In case of significant plant protein precipitation, the shelf-stable plant-based yogurt analogue would have a mean protein particle size significantly higher than 70 μm. The mean protein particle size of the shelf-stable plant-based yogurt analogue is measured by means of a laser diffraction analyzer (MasterSizer, Malvern Instruments Ltd., UK), applying the Fraunhofer optical model. Especially, the mean protein particle size is measured at room temperature with a refractive index of 1.5. The term “room temperature” relates to the normal temperature of a room, especially it means about 20° C. to about 25° C., preferably about 25° C.

In a preferred embodiment, the shelf-stable plant-based yogurt analogue is substantially free from, preferably entirely free from any added thickening agents. Examples of added thickening agents include acacia gum, agar, alginate, carrageenan, gelatin, gellan, locust bean gum, pectin, starch, xanthan gum, and mixtures thereof. In the present context, the term “starch” includes ingredients consisting only of starch but also includes starch-containing flours. Examples of starch-containing flours include cereal flour, corn flour, wheat flour, oat flour, chia seed flour, tapioca flour and mixtures thereof. In particular, the shelf-stable plant-based yogurt analogue is substantially free from, preferably entirely free from any added thickening agents selected from the list consisting of acacia gum, agar, alginate, carrageenan, gelatin, gellan, locust bean gum, pectin, starch, xanthan gum and mixtures thereof. Surprisingly, despite the second heat treatment, the shelf-stable plant-based yogurt analogue has a satisfactory smooth and thick texture and no protein precipitation is observed, without any added thickening agents. In an alternative embodiment, the shelf-stable plant-based yogurt analogue comprises at least one natural thickening agent.

In a further embodiment, the shelf-stable plant-based yogurt analogue comprises from 0.4 wt % to 2 wt % of natural thickening agent. Preferably, the shelf-stable plant-based yogurt analogue comprises 0.4 wt % to 1.5 wt %, from 0.5 wt % to 1.5 wt % or from 0.5 wt % to 1.0 wt % of natural thickening agent.

In a preferred embodiment, the natural thickening agent is pectin and/or native starch. In a more preferred embodiment, the pectin is high methoxyl pectin. In a most preferred embodiment, the pectin is citrus high methoxyl pectin.

In a particular preferred embodiment, the shelf-stable plant-based yogurt analogue comprises from 0.4 wt % to 1 wt % of pectin and/or comprises from 0.5 wt % to 1 wt % of native starch. Preferably, the shelf-stable plant-based yogurt analogue comprises 1 wt % of pectin and/or 0.9 wt % of native starch. Preferably, the pectin is a high methoxyl pectin. More preferably, the pectin is a citrus high methoxyl pectin.

The interests of using a natural thickening agent, especially pectin and/or native starch, are explained in the first aspect of the present invention.

In another embodiment, the shelf-stable plant-based yogurt analogue may further comprise algae flours, antioxidants, cocoa, colours, edible plant oil, fibres, flavours, flower essence, fruits, fruit preparation, minerals, prebiotics, sauce, solid inclusions, spices, sweeteners, tea, vegetables and/or vitamins.

In a further embodiment, the shelf-stable plant-based yogurt analogue comprises a fat content from 2.5 wt % to 12 wt %. Preferably, the fat content ranges from 2.5 wt % to 10 wt % or from 3 wt % to 5 wt %. Most preferably, the fat content is of 3.5 wt %. In a preferred embodiment, the fat content consists essentially of vegetable fat. The vegetable fat content may participate in collaboration with the proteins to the texture of the final food product, especially by improving mouthfeel of the shelf-stable plant-based yogurt analogue.

In an additional embodiment, the shelf-stable plant-based yogurt analogue has a dry matter from 11 wt % to 15 wt %, preferably from 13 wt % to 15 wt %. More preferably, the dry matter is of 13.7 wt %. The dry matter, including the protein content, participates in the texture of the final food product.

The plant-based yogurt analogue of the invention entails numerous advantages. A shelf-stable plant-based yogurt analogue product is provided, such a plant-based yogurt analogue being free from dairy components and soy components, and being shelf-stable. Said plant-based yogurt analogue is convenient and may be safely taken away or stored in shelves without the need of a cold storage at a temperature between 1° C. and 10° C. In addition, said plant-based yogurt analogue it has a thick and smooth texture and has preferably limited off-notes. Especially, the food product does not exhibit any plant protein precipitation, even in the absence of any added thickeners, despite its shelf-life of at least 3 months. More especially, the plant protein precipitation is limited, even in the presence of a significant content of protein for nutritional and texture purpose.

In a fourth aspect, the invention may relate to a food product which comprises a shelf-stable plant-based yogurt analogue according to the second aspect or the third aspect of the invention.

In a particular preferred embodiment, the food product comprises the shelf-stable plant-based yogurt analogue as an ingredient of its recipe. It is preferred that the food product preparation involves a step of mixing the shelf-stable plant-based yogurt analogue with the other component of the food product. The amount of the shelf-stable plant-based yogurt analogue in the food product will vary upon on the type of food product, the desired texture, the desired taste and the desired nutritional profile. Examples of food products according to the third aspect of the invention include batters, bites, cakes, doughs, drinks, juices, sauces, smoothies, soups and spreads.

In another embodiment, the food product is a multilayer food product and comprises one or several layers of shelf-stable plant-based yogurt analogue. The food product may comprise layers that consist of layers of biscuit, cake, dessert cream, fruit preparation, honey, mousses, sauce, solid pieces, vegetable preparation, whipped cream and mixtures thereof.

Those skilled in the art will understand that they can freely combine all features of the present invention disclosed herein. Further, features described for different embodiments of the present invention may be combined.

Furthermore, where known equivalents exist to specific features, such equivalents are incorporated as if specifically referred in this specification. Further advantages and features of the present invention are apparent from the figures and non-limiting examples.

### EXAMPLES

### Example 1: Material & Methods

Recipes of the different shelf-stable plant-based yogurt analogue variants

Five different shelf-stable plant-based yogurt analogue variants were prepared. The recipes of the five plant-based yogurt analogue variants are disclosed in Table 1.

TABLE 1

| | | | | Variant 4 | |
|---|---|---|---|---|---|
| | Variant 1 | Variant 2 | Variant 3 | Coco-1% | Variant 5 |
| | Coco-No | Coco-0.5% | Coco-1% | pectin- | Almond-1% |
| Ingredients | pectin | pectin | pectin | starch | pectin |
| Water | 76.0 wt % | 72.3 wt % | 69.2 wt % | 67.5 wt % | 75.6 wt % |
| Coconut cream | 14.0 wt % | 13.3 wt % | 12.7 wt % | 12.6 wt % | |
| Almond cream | — | — | — | — | 5.4 wt % |
| White sugar | 5.0 wt % | 4.8 wt % | 4.5 wt % | 4.5 wt % | 4.5 wt % |
| Pea protein isolate, | 5.0 wt % | 4.8 wt % | 4.5 wt % | 4.5 wt % | 4.5 wt % |
| 85% protein | | | | | |
| Concentrated pectin | — | 4.8 wt % | 9.1 wt % | 10.0 wt % | 10.0 wt % |
| solution with 10% | | | | | |
| pectin | | | | | |
| Native starch | — | — | — | 0.9 wt % | — |
| Total input | 100 wt % | 100 wt % | 100 wt % | 100 wt % | 100 wt % |
| ingredients | | | | | |

Especially, the nutritional compositions of the almond paste and the coconut cream used in the recipes of the six plant-based yogurt variants are disclosed in Table 2.

TABLE 2

| Raw | | | | | | | | | Total | | | Dry | |
|---|---|---|---|---|---|---|---|---|---|---|---|---|---|
| material | Protein | | Fat | | SFA | | Carbohydrates | | sugars | | Energy | matter | |
| Almond | 20 | wt % | 49.4 | wt % | 3.8 | wt % | 15.6 | wt % | 9.7 | wt % | 597.7 | 97 | wt % |
| paste | | | | | | | | | | | kcal | | |
| Coconut | 2.6 | wt % | 24 | wt % | 20 | wt % | 3.6 | wt % | 2.8 | wt % | 231 | 30 | wt % |
| cream | | | | | | | | | | | kcal | | |

The nutritional composition and pH of the six plant-based yogurt analogue variants are disclosed in Table 3.

TABLE 3

| Nutritional | Variant 1 | Variant 2 | Variant 3 | Variant 4 | Variant 5 |
|---|---|---|---|---|---|
| information | Coco-No | Coco- | Coco-1% | Coco-1% | Almond- |
| & pH | pectin | 0.5% pectin | pectin | pectin-starch | 1% pectin |
| Protein | 4.6 wt % | 4.3 wt % | 4.1 wt % | 4.2 wt % | 4.9 wt % |
| Fat | 3.5 wt % | 3.4 wt % | 3.3 wt % | 3.3 wt % | 3.1 wt % |
| Carbohydrate | 5.5 wt % | 5.2 wt % | 5.0 wt % | 5.8 wt % | 5.5 wt % |
| Dry matter | 13.7 wt % | 13.5 wt % | 13.3 wt % | 14.1 wt % | 15.8 wt % |
| pH | 4.5 | 4.5 | 4.5 | 4.5 | 4.5 |

Process for preparing the different variants of shelf-stable sp plant-based yogurt analogues

The plant-based yogurt analogue variant 1 comprising neither pectin nor starch has been prepared as follows. A plant-based food composition was prepared by mixing at 20° C. for 20 minutes the different ingredients of table 1. Especially, for variant 1, pea proteins, sugar, water and coconut cream were mixed. After mixing, the obtained plant-based food composition is homogenized at 200 bars to 50 bars at 60° C. and then heat-treated at 92° C. for 6 minutes. The homogenized and heat-treated plant-based food composition is inoculated with 0.02% of a starter culture comprising a Lactobacillus delbrueckii subsp. bulgaricus strain and a

Streptococcus thermophilus. After inoculation, the inoculated plant-based food composition is fermented at 43° C. until reaching a pH of 4.5 to obtain a plant-based yogurt analogue. The plant-based yogurt analogue is then smoothed in a tank and stored overnight at 4° C. to obtain a chilled plant-based yogurt analogue. Thereafter, the plant-based yogurt analogue is then heat treated at 90° C. for 1 minute to obtain a shelf-stable plant-based yogurt analogue. The shelf-stable plant-based yogurt analogue was dosed into several containers of 125 g and the containers were stored at ambient temperature (i.e. 25° C.).

For the plant-based yogurt analogue variants comprising pectin only, that-is-to-say plant-based yogurt analogue variants 2-3 and 5, the process is substantially the same as the process used for variant 1. The only differences are the following:
the ingredients mixed during the first step and their content are different (cf. Table 1),
the pectin is added at its targeted content just before the smoothing step.

For the plant-based yogurt analogue variant 4 comprising both pectin and starch, the process is substantially the same as the process used for variant 1. The only differences are following:
the ingredients mixed during the first step and their content are different (cf. table 1),
the starch is mixed with the other ingredients of the plant-based food composition during the first step,
the pectin is added at its targeted content just before the smoothing step.

Measurement of the Particle Size Distribution

The particle size distribution (PSD) of the different samples, the plant-based yogurt analogue variants included, was determined using a laser diffraction analyzer (MasterSizer, Malvern Instruments Ltd., UK), applying the Fraunhofer optical model. Measurements were performed at room temperature using a refractive index of 1.5. Each sample was run in triplicate.

Optical Microscopy

The microstructure of the different samples, the plant-based yogurt analogue variants included, was observed by optical microscopy using the Microscope BX50. Samples were diluted to 1/50th in distilled water.

Rheological Properties: Back-Extrusion Tests

The mechanical properties of the different samples, the plant-based yogurt analogue variants included, were characterized based on a pseudo-compression (“back-extrusion”) test using a TAX-T2 Texture Analyzer (TA Instruments, Stable Micro Systems, UK). A 30 mm diameter cylindrical flat probe penetrated into the sample at a crosshead speed of 0.5 mm·s−1 and to a depth of 30 mm at 8° C. The maximal force obtained from this test was analyzed.

The measures were performed at 1 day after fermentation on 30 g samples of the different plant-based yogurt analogue variants. The samples are stored at a temperature of 10° C. for a minimum of 2 hours prior to measurement.

### Example 2: Structural Properties of Plant-Based Food Composition Before Fermentation

The particle size distribution (PSD) of the following samples were measured:
the coconut cream;
the plant-based food composition of variant 1 (cf. Table 1);
the plant-based food composition of variant 4 (cf. Table 1).

The recipe of the plant-based food composition of variant 1 is identical to the recipe of variant 1 disclosed in Table 1.

As the pectin is added after fermentation, the recipe of the plant-based food composition of variant 4 does not comprise pectin. For more details, the recipe of the non-soy plant-based food composition of variant 4 is provided in Table 4.

TABLE 4

| Ingredients | Amount |
|---|---|
| Water | 75 wt % |
| Coconut cream | 14 wt % |
| White sugar | 5 wt % |
| Pea protein isolate, 85% protein | 5 wt % |
| Native starch | 1 wt % |

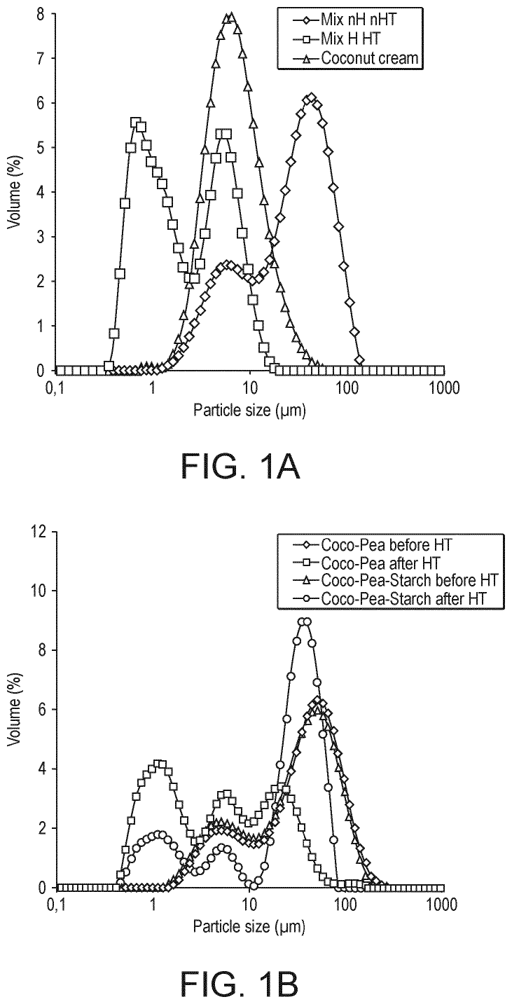

The particle sizes of the different samples were measured just after the mixing step (non homogenized and non heat-treated) or after the homogenization and heat-treatment steps (cf. FIGS. 1A and 1B).

One main peak centered to 8-10 μm is present in the untreated coconut cream, which is mainly due to the fat emulsion. Addition of pea proteins to the coconut cream in variant 1, caused an additional peak to appear between 10 and 150 μm, which is due to the insoluble particles of pea proteins. A homogenization and heat-treatment steps allow the rupture of the large pea protein particles into smaller particles, limiting considerably the sedimentation and particle size.

Addition of starch to the coconut and pea mixture, namely variant 4, before homogenization and heat-treatment seems to have no significant effect on the PSD, however, it must be noticed that the size of the native starch granules are comprised between 30 and 80 μm, they are thus masked by the pea proteins of similar size. During the heat-treatment, the native starch granules swell and may partially disrupt, giving rise to “ghosts granules” with a main PSD centered to 50-60 μm.

### Example 3: Structural Properties of the Shelf-Stable Plant-Based Yogurt Analogues without Addition of Hydrocolloid

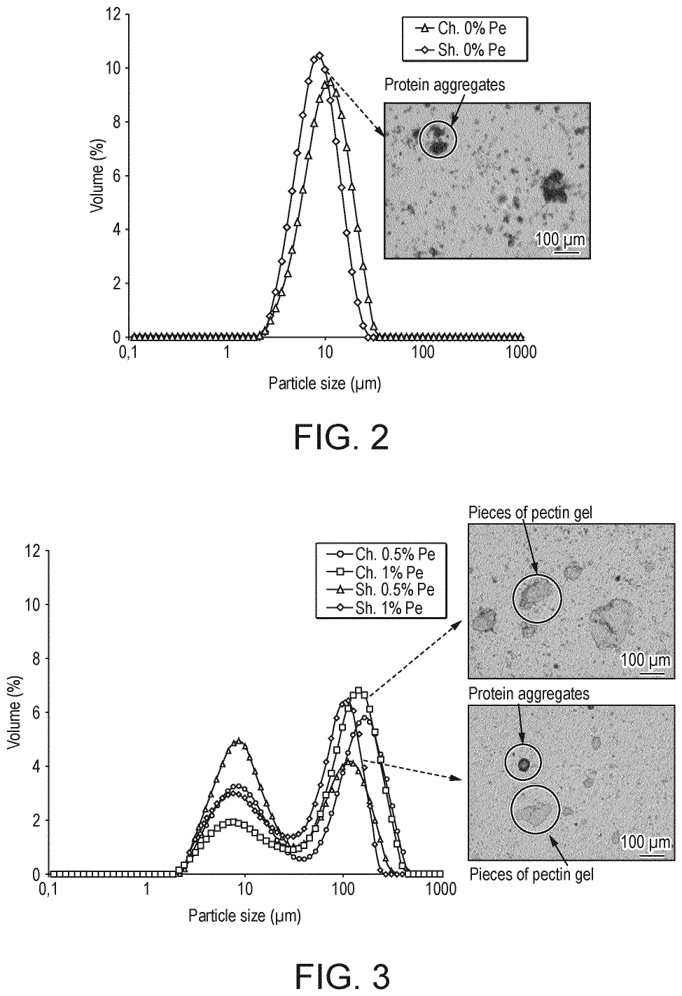

The particle size distribution (PSD) of plant-based yogurt analogue variant 1 (cf. Example 1) was measured after fermentation, especially either before (chilled) or after (shelf-stable) the second heat treatment (FIG. 2).

Just after fermentation and smoothing, the chilled version of variant 1 has a main peak of particles centered to 10 μm. The shelf-stable version of variant 1 that has been undergone a second heat-treatment shows a main peak of particles centered to 9 μm (slight shift in lower particles size compared to the chilled version). For both products, there is no peak that could correspond to protein precipitation. It should be noted that for the visual aspect, the products were smooth without any visible particles (visually and in mouth), which was confirmed by optical microscopy (FIG. 2).

Therefore, applying a second heat-treatment of 90° C. for 1 minute to a plant-based yogurt analogue does not cause any protein precipitation.

### Example 4: Effect of Pectin Addition on Structural Properties of Shelf-Stable Plant-Based Yogurt Analogues

Tests with pectin added in the chilled plant-based yogurt analogue, before the second heat-treatment were performed. Two levels of pectin were tested: 0.5% (variant 2) and 1% (variant 3), added through a concentrated solution of 10% pectin into the chilled plant-based yogurt analogue (cf. Example 1). The particle size distribution of the chilled plant-based yogurt analogue or shelf-stable plant-based yogurt analogue with 0.5% (variant 2) or 1% (variant 3) pectin is shown in FIG. 3.

Addition of pectin, either for chilled or shelf-stable plant-based yogurt analogues led to a bimodal distribution, with one peak centered to 10 μm and another peak centered to 100 μm. The images obtained by optical microscopy help to identify the composition of the 2 peaks: the first peak centered to 10 μm was mainly due to pieces of yogurt analogue gel whereas the larger particles corresponding to the peak centered to 100 μm were composed of pieces of pectin gel (FIG. 3). Especially, this peak centered to 100 μm is not linked to proteins.

There is a slight decrease in size of the peak centered to 100 μm for lower pectin concentration (i.e. 0.1% pectin) and when a second heat-treatment was applied. However, it must be noted that the large pieces of pectin gel were present not only just after the addition of the solution of pectin in the chilled plant-based yogurt analogue but also after the second heat-treatment carried out on the plant-based yogurt analogue, and whatever the final content of pectin (0.5 or 1%).

Whatever the level of pectin, the shelf-stable plant-based yogurt analogues were smooth without any particles perceived visually and in mouth.

Therefore, applying a second heat-treatment of 90° C. for 1 minute to a plant-based yogurt analogue comprising pectin does not cause any protein precipitation.

### Example 5: Effect of the Type of Plant-Based Milk Alternative on Structural Properties of Shelf-Stable Plant-Based Yogurt Analogues

Two types of non-dairy plant-based milk alternatives prepared with plant-based cream alternatives (i.e. coconut cream or almond cream), were evaluated: coconut milk and almond milk.

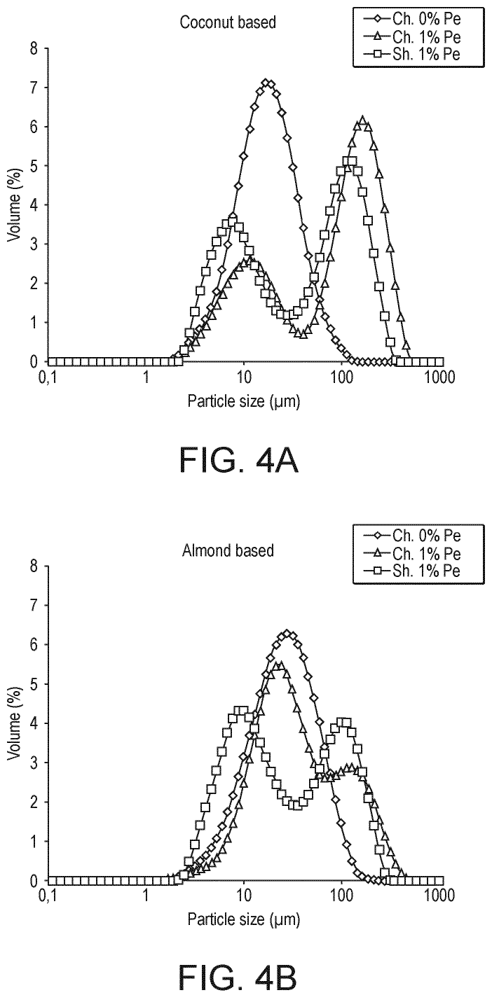

Especially, the plant-based yogurt analogue variant 3 (cf. Example 1) comprising coconut milk prepared with coconut cream was assessed at different stage:
before fermentation: the plant-based food composition of variant 3 (FIG. 4A, Ch. 0% Pe),
just after the addition of pectin (1% pectin) and the smoothing step: chilled version of plant-based yogurt analogue variant 3 (FIG. 4A, Ch. 1% Pe),
after the second heat treatment: shelf-stable version of plant-based yogurt analogue variant 3 (FIG. 4A, Sh. 1% Pe).

The plant-based yogurt analogue variant 5 (cf. Example 1) comprising almond milk prepared with almond cream was assessed at different stage:
before fermentation: the plant-based food composition of variant 5 (FIG. 4B, Ch. 0% Pe),
just after the addition of pectin (1% pectin) and the smoothing step: chilled version of plant-based yogurt analogue variant 5 (FIG. 4B, Ch. 1% Pe),
after the second heat treatment: shelf-stable version of plant-based yogurt analogue variant 5 (FIG. 4B, Sh. 1% Pe).

The particle size distribution of the chilled and shelf-stable plant-based yogurt analogues was analyzed for variant 3 (FIG. 4A) and variant 5 (FIG. 4B).

For the chilled plant-based yogurt analogues, the particle sizes of the chilled coconut-based yogurt analogue (variant 3) were slightly smaller than for the chilled almond-based yogurt analogue (variant 5). However, both variants were smooth in mouth with no visible particles. For both types of plant-based milk alternatives, addition of pectin in the chilled plant-based yogurt analogue caused an additional peak centered to 100 μm which was due to pieces of pectin gel (FIG. 3 and FIGS. 4A and 4B). Especially, this additional peak has no link with proteins. For the shelf-stable plant-based yogurt analogues, the second heat-treatment did not modify significantly the particle size distribution of the plant-based yogurt analogues containing pectin, for both types of plant milk.

Therefore, it seems that whatever the type of plant-based milk alternatives (coconut versus almond), no protein precipitation was observed in the shelf-stable plant-based yogurt analogues.

### Example 6: Effect of Addition of Starch on Structural Properties of Shelf-Stable Plant-Based Yogurt Analogues

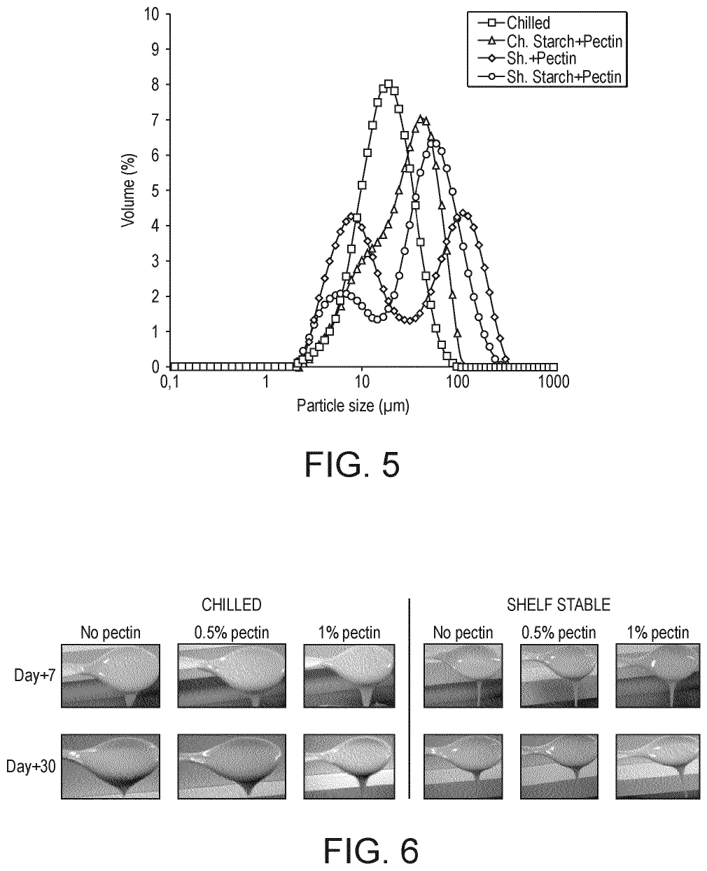

Native starch was added in variant 4 to try to increase the texture of the shelf-stable plant-based yogurt analogues. The particle size distribution of the chilled and shelf-stable plant-based yogurt analogues was analysed (cf. FIG. 5):
without addition of any starch, including native starch: corresponds to variant 3;
with addition of native starch: corresponds to variant 4.

Addition of starch caused an additional peak around 50-60 μm, which may be due to the presence of swollen starch granules swells and/or to disrupted ghosts granules (cf. FIG. 5). This aspect has already been discussed in Example 2 for the plant-based food compositions containing starch (cf. FIG. 1B). To prepare the shelf-stable yogurt analogues, pectin was added in the chilled yogurt before the heat-treatment, giving rise to a peak around 100 μm consisting of pieces of pectin gel (not linked to proteins) (cf. FIG. 5). The presence of starch in the shelf-stable plant-based yogurt analogues may partially mask the peak corresponding to the pieces of pectin gel and/or may contribute to decrease the presence of pieces of pectin gel by disturbing their formation.

The plant-based yogurt analogue variants 5 containing starch, especially shelf-stable versions of variant 5, were smooth. Especially, no peaks related to protein precipitation were observed by granulometry.

### Example 7: Effect of a Second Heat-Treatment, Hydrocolloids, Types of Milk Alternatives and Fruit Addition on Texture

The effect of a second heat-treatment after fermentation on the visual aspect and texture of the final products was studied. FIG. 6 shows the visual aspect of the chilled and shelf-stable plant-based yogurt analogue variants without or with addition of pectin at 7 days after manufacturing the variants (day+7) and 30 days after manufacturing the variants (day+30). The samples without pectin correspond to plant-based yogurt analogue variant 1, the samples with 0.5% pectin correspond to plant-based yogurt analogue variant 2 and the samples comprising 1% pectin correspond to plant-based yogurt analogue variant 3 (cf. Example 1).

The chilled plant-based yogurt analogues were significantly higher in texture compared to the shelf-stable plant-based yogurt analogues, whatever the amount of pectin. There was a slight increase in texture observed visually along the time of storage.

All the plant-based yogurt analogues (chilled or shelf-stable, without or with addition of pectin) were smooth and homogeneous. All the plant-based yogurt analogues have a visual texture that seems to mimic the texture of standard spoonable dairy yogurts.

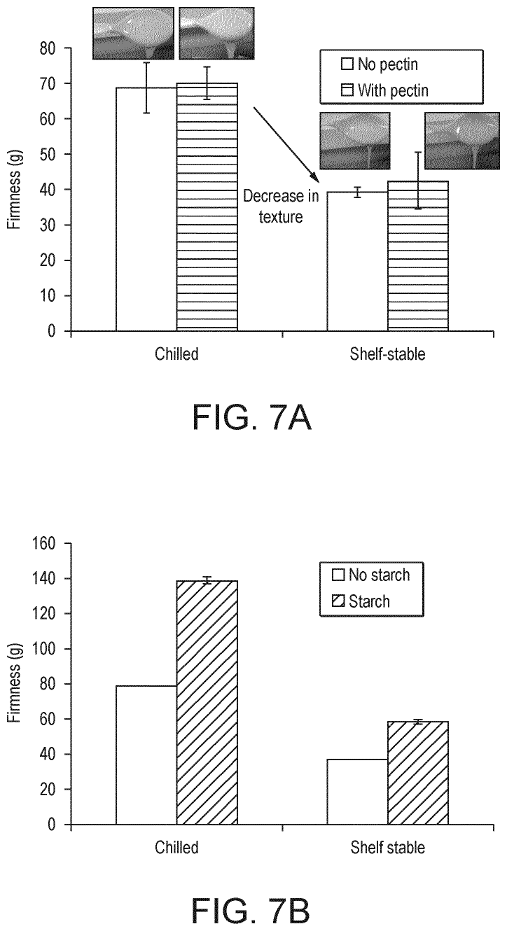

The firmness of different chilled and shelf-stable plant-based yogurt analogue variants was evaluated through a back-extrusion test (FIGS. 7A and 7B). Especially, the firmness was assessed on (cf. Example 1+FIGS. 7A and 7B):
a plant-based yogurt analogue variant without pectin (no pectin): plant-based yogurt analogue variant 1 (FIG. 7A),
a plant-based yogurt analogue variant with 1% pectin (with pectin) and without starch (no starch): plant-based yogurt analogue variant 3 (FIGS. 7A and 7B),
a plant-based yogurt analogue variant with 1% pectin and with starch (starch): plant-based yogurt analogue variant 4 (FIG. 7B).

FIGS. 7A and 7B show the effect of pectin or starch addition on the texture of chilled and shelf-stable plant-based yogurt analogues.

The shelf-stable yogurt analogues were significantly less firm than the chilled plant-based yogurt analogues, whatever the pectin or starch content, which is consistent with the visual aspects observed on FIG. 6. However, after the second heat-treatment, the firmness of the shelf-stable plant-based yogurt analogues is satisfactory and mimics the texture of standard spoonable dairy yogurts.

Addition of pectin for chilled and shelf-stable plant-based yogurt analogue variants had low effect on texture, whereas addition of starch significantly increased the firmness of the plant-based yogurt analogues, for both chilled and shelf-stable versions. Without wishing to be bound by theory, this may be due to the swollen and/or disrupted starch granules that act by space occupation in the matrix. It must be noted that addition of starch for the shelf-stable plant-based yogurt analogues (e.g. variant 4) nearly compensates the loss of texture caused by the second heat-treatment performed on the chilled plant-based yogurt analogue. Addition of native starch could thus be a clean label solution to increase the texture of the shelf-stable plant-based yogurt analogues.

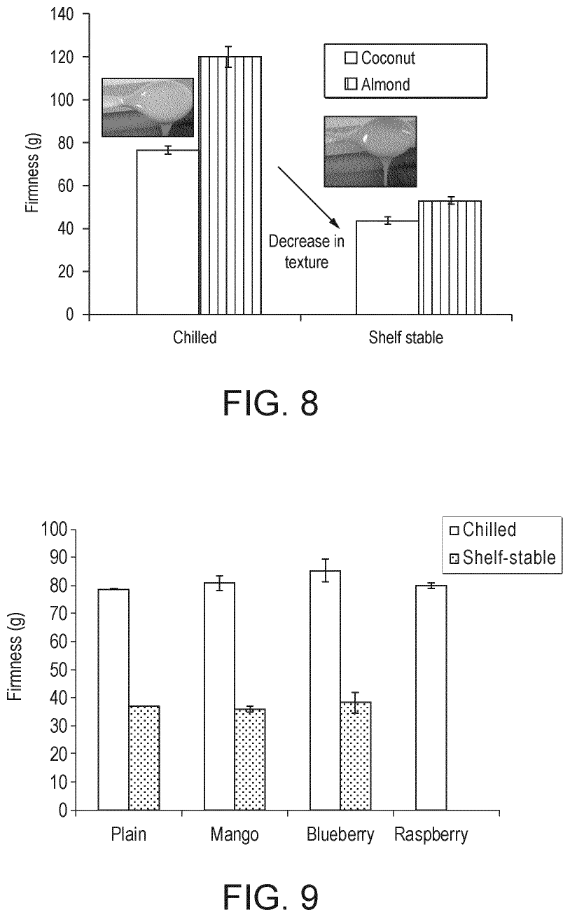

The firmness of chilled and shelf-stable version of the coconut-based yogurt analogue variant 3 and the almond-based yogurt analogue variant 5 (cf. Example 1) were analyzed (FIG. 8).

For both chilled and shelf-stable versions, the coconut-based yogurt analogue variant were lower in texture than the almond-based yogurts. This may be explained by the higher protein content and dry matter in the almond cream compared to the coconut cream (Table 2). Whatever the type of plant-based milk alternative used, the resulting chilled and shelf-stable plant-based yogurt analogue variants have satisfactory textures that mimic the texture of standard spoonable dairy yogurts.

14% of different fruit preparations were added to the chilled and shelf-stable version of plant-based yogurt analogue variant 1. FIG. 9 shows the firmness of the plant-based yogurt analogue variant 1 depending on the type of fruit preparation.

As discussed previously, the chilled versions of variant 1 were firmer than the shelf-stable versions of variant 1. Addition of mango, blueberry or raspberry preparation did not significantly influence the texture of the final products.

Although the invention has been described by way of example, it should be appreciated that variations and modifications may be made without departing from the scope of the invention as defined in the claims.

1. Process for preparing a shelf-stable plant-based yogurt analogue, which comprises the steps of:
(a) providing a plant-based food composition comprising a hydrophilic liquid, a fermentable sugar, and plant proteins, wherein said plant-based food composition comprises from 3.5_wt % to 6.0_wt % of plant proteins, wherein the plant-based food composition is free from soy and dairy components,
(b) homogenizing the plant-based food composition at a pressure from 50 bar to 700 bar,
(c) heat treating the plant-based food composition at a temperature from 80° C. to 100° C. for 1 minute to 10 minutes,
(d) inoculating the heat-treated and homogenized plant-based food composition with at least one starter culture to obtain an inoculated plant-based food composition,
(e) fermenting the inoculated plant-based food composition until reaching a pH from 4.5 and 6.2, preferably from 4.5 to 5.0, to obtain a plant-based yogurt analogue, and heat treating the plant-based yogurt analogue at a temperature from 80° C. to 110° C. for 5 seconds to 90 seconds to obtain a shelf-stable plant-based yogurt analogue.

2. Process according to claim 1, wherein the fermentable sugar is sucrose.

3. Process according to claim 1, wherein the plant-based food composition comprises from 3_wt % to 10_wt % of fermentable sugar.

4. Process according to claim 1, wherein the plant proteins are pulse proteins.

5. Process according to claim 1, wherein the homogenization step is performed at a temperature from 50° C. to 60° C.

6. Process according to claim 1, wherein the shelf-stable plant-based yogurt analogue has a shelf-life of at least 3 months at a temperature of 20° C. to 35° C.

7. Process according to claim 1, wherein the shelf-stable plant-based yogurt analogue has a firmness (g) of at least 35 g at 8° C., at 8° C. measured by means of a texturometer with a 30 mm diameter cylindrical flat probe penetrating at a crosshead speed of 0.5 mm·s⁻¹ and to a depth of 30 mm and has a viscosity of at least 0.4 Pa·s at 60 s⁻¹ at 10° C. measured by means of a rheometer with coaxial cylinders.

8. Process according to claim 1, wherein the shelf-stable plant-based yogurt analogue has a mean protein particle size ranging from 1 μm to 70 μm, measured at room temperature by means of a laser diffraction analyzer, applying the Fraunhofer optical model, with a refractive index of 1.5.

9. Process according to claim 1, wherein the shelf-stable plant-based yogurt analogue is substantially free from any added thickening agents.

10. Process according to claim 1, which further comprises after step (e) and prior to step (f) the addition of at least one natural thickening agent.

11. Process according to claim 1, wherein the plant-based food composition of step (a) further comprises at least one natural thickening agent, preferably native starch.

12. Process according to claim 10, wherein the shelf-stable plant-based yogurt analogue comprises from 0.4_wt % to 2.0_wt % of natural thickening agent.

13. A shelf-stable plant-based yogurt analogue obtained by the process of claim 1.

14. A shelf-stable plant-based yogurt analogue, wherein said shelf-stable plant-based yogurt analogue is free from soy and dairy components and said shelf-stable plant-based yogurt analogue comprises:
a hydrophilic liquid,
a fermentable sugar,
plant proteins,
and said shelf-stable plant-based yogurt analogue has:
a pH of 4.5 to 6.2, preferably of 4.5 to 5.0,
from 3.5_wt. % to 6.0_wt. % of plant protein, and
a shelf-life of at least 3 months at a temperature of 20° C. to 35° C.

15. A shelf-stable plant-based yogurt analogue according to claim 14, which has a firmness (g) of at least 35 g at 8° C., measured by means of a texturometer with a 30 mm diameter cylindrical flat probe penetrating at a crosshead speed of 0.5 mm·s⁻¹ and to a depth of 30 mm, and has a viscosity of at least 0.4 Pa·s at 60s⁻¹ at 10° C., measured by means of a rheometer with coaxial cylinders.

16. A shelf-stable plant-based yogurt analogue according to claim 14, which has a mean protein particle size ranging from 1 to 70 μm measured at room temperature by means of a laser diffraction analyzer, applying the Fraunhofer optical model, with a refractive index of 1.5.

17. (canceled)
